(19) United States
(12) Patent Application Publication
(10) Pub. No.: US 2026/0190039 A1
(43) Pub. Date: Jul. 2, 2026

(54) AUTOMATICALLY ADJUSTING THE OPERATION OF UNMANNED AERIAL VEHICLES TO AVOID BASE STATION RECEIVE POWER SATURATION

(71) Applicants: AT&T Intellectual Property I, L.P., Atlanta, GA (US); AT&T Technical Services Company, Inc., Vienna, VA (US)

(72) Inventors: Daniel Vivanco, Ashburn, VA (US); Yupeng Jia, South Pasadena, CA (US)

(21) Appl. No.: 19/006,103

(22) Filed: Dec. 30, 2024

(51) Int. Cl. H04W 52/24; H04W 52/28; H04W 52/36; H04W 84/06

(52) U.S. Cl. CPC H04W 52/245; H04W 52/285; H04W 52/36; H04W 84/06

(57) ABSTRACT

A method for automatically adjusting the operation of unmanned aerial vehicles to avoid base station receive power saturation includes monitoring a current value of a received signal strength indicator of a base station of a wireless communications network that is serving a plurality of user equipment, determining that the current value of the received signal strength indicator is greater than a threshold value, identifying a first user equipment of the plurality of user equipment for which a contribution to the current value of the received signal strength indicator is largest, and sending an instruction to the first user equipment to cause the first user equipment to adjust at least one of: a current transmit power of the first user equipment, a physical distance of the first user equipment from the base station, or a current serving cell of the first user equipment.

The present disclosure relates generally to wireless communications networks, and relates more particularly to devices, non-transitory computer-readable media, and methods for automatically adjusting the operation of unmanned aerial vehicles to avoid base station receive power saturation.

### BACKGROUND

Next-generation 911 (NG911 ) and similar services utilize both manned vehicles and unmanned vehicles, including unmanned aerial vehicles (UAVs, e.g., drones), to expand surveillance areas and improve data collection for the purposes of responding to emergencies. For instance, UAVs may be deployed to areas where large crowds are expected to gather for a short period of time (e.g., for a sports event, a festival, a political inauguration, or the like). The UAVs may gather information that can help first responders in detecting and responding to emergencies safely and efficiently.

### SUMMARY

In one example, the present disclosure describes a device, computer-readable medium, and method for automatically adjusting the operation of unmanned aerial vehicles to avoid base station receive power saturation. For instance, in one example, a method performed by a processing system including at least one processor includes monitoring a current value of a received signal strength indicator of a base station of a wireless communications network that is serving a plurality of user equipment, determining that the current value of the received signal strength indicator is greater than a threshold value, identifying a first user equipment of the plurality of user equipment for which a contribution to the current value of the received signal strength indicator is largest, and sending an instruction to the first user equipment to cause the first user equipment to adjust at least one of: a current transmit power of the first user equipment, a physical distance of the first user equipment from the base station, or a current serving cell of the first user equipment.

In another example, a non-transitory computer-readable medium stores instructions which, when executed by the processing system, cause the processing system to perform operations. The operations include monitoring a current value of a received signal strength indicator of a base station of a wireless communications network that is serving a plurality of user equipment, determining that the current value of the received signal strength indicator is greater than a threshold value, identifying a first user equipment of the plurality of user equipment for which a contribution to the current value of the received signal strength indicator is largest, and sending an instruction to the first user equipment to cause the first user equipment to adjust at least one of: a current transmit power of the first user equipment, a physical distance of the first user equipment from the base station, or a current serving cell of the first user equipment.

In another example, a system includes a processing system including at least one processor and a non-transitory computer-readable medium storing instructions which, when executed by the processing system, cause the processing system to perform operations. The operations include monitoring a current value of a received signal strength indicator of a base station of a wireless communications network that is serving a plurality of user equipment, determining that the current value of the received signal strength indicator is greater than a threshold value, identifying a first user equipment of the plurality of user equipment for which a contribution to the current value of the received signal strength indicator is largest, and sending an instruction to the first user equipment to cause the first user equipment to adjust at least one of: a current transmit power of the first user equipment, a physical distance of the first user equipment from the base station, or a current serving cell of the first user equipment.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for automatically adjusting the operation of unmanned aerial vehicles to avoid base station receive power saturation may operate;

FIG. 2 illustrates a flowchart of an example method for automatically adjusting the operation of unmanned aerial vehicles to avoid base station receive power saturation, according to the present disclosure;

FIG. 3 illustrates a flowchart of an example method for automatically adjusting the operation of unmanned aerial vehicles to avoid base station receive power saturation, according to the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for automatically adjusting the operation of unmanned aerial vehicles to avoid base station receive power saturation. As discussed above, next-generation 911 (NG911 ) and similar services utilize both manned vehicles and unmanned vehicles, including (UAVs, e.g., drones), to expand surveillance areas and improve data collection for the purposes of responding to emergencies. For instance, UAVs may be deployed to areas where large crowds are expected to gather for a short period of time (e.g., for a sports event, a festival, a political inauguration, or the like). The UAVs may gather information that can help first responders in detecting and responding to emergencies safely and efficiently.

The UAVs used by first responders tend to be larger than recreational (e.g., civilian use) UAVs. For instance, the UAVs used by first responders may include amplifiers in the transmit radio frequency (RF) path to boost signal power, which allows the UAVs to transmit at a higher transmit power (e.g., ten Watts or more) than recreational UAVs (which tend to transmit at a transmit power closer to two hundred milliwatts). As a UAV transmitting at this higher transmit power flies closer to a base station of a wireless network (e.g., an eNodeB or gNodeB), the likelihood of saturation at the base station increases.

In Fourth Generation (4G) and Fifth Generation (5G) wireless networks, receiver saturation (also referred to as front-end overload) is the maximum RF power that a base station can tolerate. If a base station becomes saturated, the physical uplink shared channel (PUSCH) of the base station may collapse, and the signal-to-noise ratio (SNR) may drop, which would negatively affect the base station's uplink throughput to all user equipment (UEs) attached to the cell that is served by the base station.

A single recreational UAV is unlikely to induce receiver saturation at a base station since the transmit power of a recreational UAV is relatively low; however, a large number of recreational UAVs flying close to a base station could potentially induce receiver saturation. Moreover, a single larger UAV (or a few larger UAVs) flying close to the base station could also induce receiver saturation at the base station.

Examples of the present disclosure leverage Third Generation Partnership Project (3GPP) uplink power control mechanisms to automatically adjusting the operation of unmanned aerial vehicles to minimize base station receive power saturation. 3GPP defines two different mechanisms for uplink power control: open loop power control (OLPC) and close loop power control (CLPC). In OLPC, a UE determines its transmit power (e.g., though a local power setting algorithm that processes multiple inputs, including UE internal settings and measurements), without feedback from the base station. In CLPC, a UE uses a similar power setting algorithm to determine an initial power needed by the UE to communicate with a base station. Subsequently, UE transmit power is controlled dynamically using feedback (i.e., transmission power control (TPC) commands) from the base station. In both OLPC and CLPC, the goal is to conserve the battery power of the UE. Broadly, as a UE's location draws closer to the base station of the serving cell, the UE's transmit power is reduced to conserve battery power; the UE's transmit power is only increased (which increases battery consumption) as the UE's location moves away from the base station. Neither OLPC nor CLPC considers the possibility of base station saturation or provides feedback related to saturation to the UE.

However, examples of the present disclosure implement a functionality in the base station of a wireless network which allows the base station to monitor for potential saturation conditions and to provide feedback to UEs, and to larger UAVs particularly, to minimize the potential of saturation occurring. In one example, when the uplink received signal strength indicator (RSSI) of the base station exceeds a threshold, the base station may detect the UEs that contribute the most to the RSSI, and may calculate a reduced transmit power for these UEs that will lower the RSSI. The base station may then request that the UEs lower their transmit power to the reduced transmit power. Alternatively, the base station may request that the UEs change their trajectory to increase their distances from the base station (or even force a handover to a different base station), which will have a similar effect to reducing the transmit power. In another example, the base station may detect that a UE being served by the base station is a larger (e.g., non-recreational) UAV that is likely to cause saturation, and may request that the UE reduce its transmit power even before the RSSI exceeds the threshold.

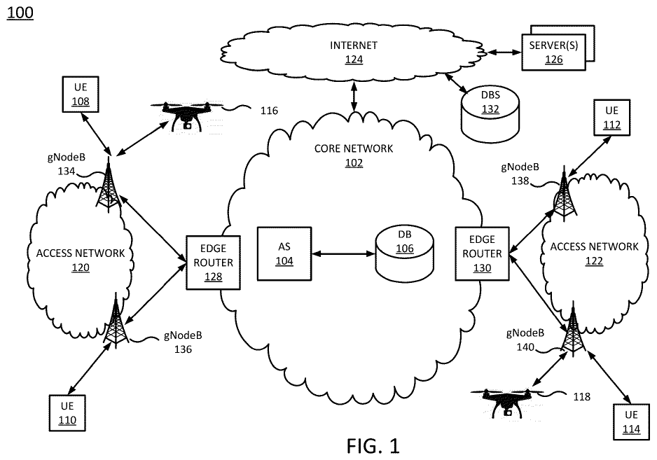

Although examples of the present disclosure are discussed within the context of first responder systems, it will be appreciated that examples of the present disclosure may improve the use of unmanned aerial vehicles in other applications as well, including industrial and military applications. These and other aspects of the present disclosure are discussed in further detail with reference to FIGS. 1-4, below.

To further aid in understanding the present disclosure, FIG. 1 illustrates an example system 100 in which examples of the present disclosure for automatically adjusting the operation of unmanned aerial vehicles to avoid base station receive power saturation may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

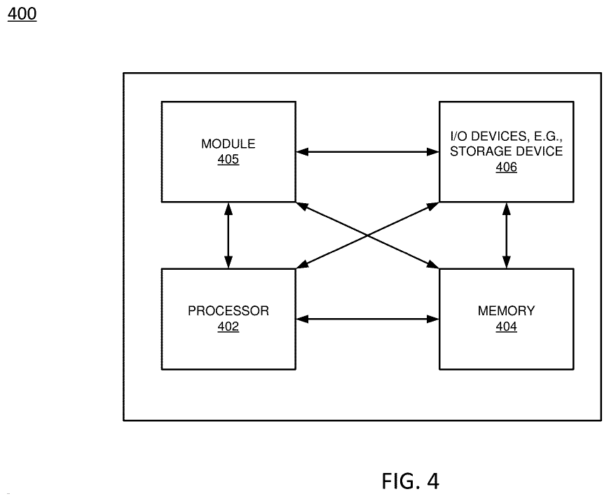

In one example, the access network 120 may be in communication with one or more user endpoint devices 108, 110, and 116. Similarly, the access network 122 may be in communication with one or more user endpoint devices 112, 114, and 118. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 400 depicted in FIG. 4, and may be configured as described below. For example, the user endpoint devices 108, 110, 112, and 114 may each comprise a smart phone, a tablet computer, a laptop computer, a gaming device, a wearable smart device (e.g., a smart watch, smart glasses, or the like), an Internet of Things (IoT) device, a bank or cluster of such devices, and the like.

In one example, at least some of the user endpoint devices, e.g., devices 116 and 118 in FIG. 1, may comprise unmanned aerial vehicles (UAVs). In one example, the UAVs 116 and 118 may comprise larger, non-recreational UAVs, such as the types of UAVs used by first responders, as well as in industrial, military, commercial, and other applications. For instance, the UAVs 116 and 118 may be capable of transmitting at ten or more Watts (e.g., as opposed to the approximately two hundred milliwatts that is more typical of recreational UAVs). These types of UAVs typically require beyond visual line of sight (LOS) communications. The access networks 120 and 122 may offer wide area, high speed, and secure wireless connectivity, which can enhance the control and safety of the UAV operations and enable beyond LOS use cases.

However, because the UAVs 116 and 118 may transmit at significantly higher power than other UEs 108, 110, 112, and 114, the UAVs 116 and 118 run the risk of saturating the base stations 134, 136, 138, or 140 that serve UAVs 116 and 118. As discussed above, saturation may result in loss of connectivity for all UEs 108, 110, 112, 114, 116, and 118 in the cell served by the saturated base station.

According to examples of the present disclosure, to minimize the likelihood of saturation, a base station 134, 136, 138, or 140 may implement operations that provide feedback to UEs 108, 110, 112, and 114, and particularly to large, high powered UAVs 116 and 118, when the base station 134, 136, 138, or 140 detects that saturation may be likely. For instance, the base station 134, 136, 138, or 140 may monitor the value of its uplink received signal strength indicator (RSSI), which indicates an aggregate of the uplink power being transmitted to the base station 134, 136, 138, or 140 by all of the UEs 108, 110, 112, and 114 (and including UAVs 116 and 118, if applicable) being served by the base station 134, 136, 138, or 140. If value of the uplink RSSI exceeds a threshold RSSI value, then the base station 134, 136, 138, or 140 may provide instructions to the UAVs 116 and/or 118 to adjust their operations.

In one example, the base station 134, 136, 138, or 140 may instruct a UAV 116 or 118 to reduce its transmit power to a level that will cause the value of the uplink RSSI to be lowered below the threshold RSSI value. In another example, the base station 134, 136, 138, or 140 may instruct the UAV 116 or 118 to increase the distance between the base station 134, 136, 138, or 140 and the UAV 116 or 118, which will effectively lower the transmit power from the UAV 116 or 118 that is received by the base station 134, 136, 138, or 140. In yet another example, the base station 134, 136, 138, or 140 may instruct the UAV 116 or 118 to attach itself to a different base station 134, 136, 138, or 140.

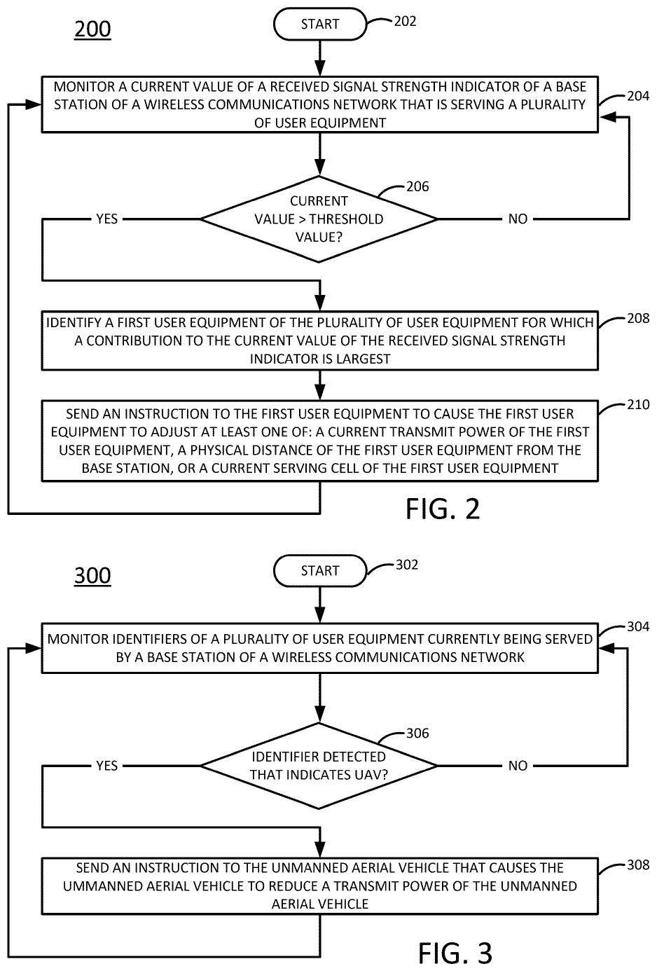

In other examples, a base station 134, 136, 138, or 140 may monitor identifiers of UEs 108, 110, 112, 114 (including UAVs 116 and 118, is applicable) that are being served by the base station 134, 136, 138, or 140. Based on the identifiers, the base station 134, 136, 138, or 140 may be able to determine whether a UE being served is a large, high powered UAV such as the UAVs 116 and 118. If the base station 134, 136, 138, or 140 determines that it is currently serving a large, high powered UAV 116 or 118, then the base station may proactively instruct the large, high powered UAV 116 or 118 to lower its transmit power even before the value of the base station's uplink RSSI begins to approach the threshold RSSI value. For instance, example methods for automatically adjusting the operation of unmanned aerial vehicles to avoid base station receive power saturation are discussed in further detail below in connection with FIG. 2 and FIG. 3.

In one example, one or more servers 126 and one or more databases 132 may be accessible to user endpoint devices 108, 110, 112, 114, 116, and 118 via Internet 124 in general. The server(s) 126 and DBs 132 may be associated with Internet software applications that may exchange data with the user endpoint devices 108, 110, 112, and 114 over the Internet 124. In one example, at least some of the servers 126 and DBs 132 host applications that may receive continuous uplink video transmissions from the UAVs 116 and 118 and analyze the video transmissions to facilitate responses to emergencies.

In accordance with the present disclosure, the AS 104 may also be configured to host applications that may receive continuous uplink video transmissions from the UAVs 116 and 118 and analyze the video transmissions to facilitate responses to emergencies. In one example, at least one of the DBs 106 or 132 may store video transmissions from the UAVs 116 and 118 for analysis by the AS 104 and/or servers 126.

The AS 104 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for analyzing video transmissions provided by UAVs 116 and 118.

In some examples, any of the servers 126 and/or AS 104 may be configured to perform the operations for monitoring the uplink RSSI values of the base stations 134, 136, 138, and 140 and for instructing large, high powered UAVs 116 and 118 to adjust their operations to minimize the likelihood of saturating the base stations 134, 136, 138, and 140, as discussed above (e.g., the operations for automatically adjusting the operation of unmanned aerial vehicles to avoid base station receive power saturation, as discussed in further detail below in connection with FIG. 2 and FIG. 3). For instance, any of the servers 126 and/or AS 104 may be configured as a self-optimizing network (SON) controller, a radio intelligent controller (RIC), or the like.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

To further aid in understanding the present disclosure, FIG. 2 illustrates a flowchart of an example method 200 for automatically adjusting the operation of unmanned aerial vehicles to avoid base station receive power saturation, according to the present disclosure. In one example, the method 200 may be performed by a base station of a radio access network, such as one of the base stations 134, 136, 138, or 140 illustrated in FIG. 1 or one or more components thereof (e.g., a processor or controller of the base station). However, in other examples, the method 200 may be performed by another device, such as the computing system 400 of FIG. 4, discussed in further detail below. For the sake of discussion, the method 200 is described below as being performed by a processing system (where the processing system may comprise a component of a base station 134, 136, 138, 140, the computing system 400, or another device).

The method 200 begins in step 202. In step 204, the processing system may monitor a current value of a received signal strength indicator of a base station of a wireless communications network that is serving a plurality of user equipment.

In one example, the wireless communications network comprises a radio access network (RAN), such as an LTE, 4G, 5G, or beyond 5G (B5G) network. Thus, the base station may comprise an eNodeB or a gNodeB. In one example, the RSSI is an uplink RSSI. Thus, the uplink RSSI may measure the collective power of the uplink radio signals received by the base station from the plurality of user equipment. The plurality of user equipment may include various types of mobile devices, including smart phones, tablet computers, portable gaming consoles, wearable smart devices (e.g., fitness trackers, smart watches, smart glasses, or the like), UAVs, autonomous vehicles, Internet of Things (IoT) devices, and the like.

In step 206, the processing system may determine whether the current value of the received signal strength indicator is greater than a threshold value. As discussed above, if the RF power received by the base station exceeds the maximum RF power that the base station can tolerate, then the base station may become saturated. If the base station becomes saturated, then the PUSCH of the base station may collapse, and the SNR may drop, which would negatively affect the base station's uplink throughput to all UEs of the plurality of UEs. High uplink RSSI power at a base station is an indicator of saturation (or near-saturation), as the uplink RSSI represents the collective or aggregated received power at the base station PUSCH.

Base stations including eNodeBs usually include amplifiers in both the transmit and receive paths, so the transmit power of the plurality of UEs will be amplified at the base station receiver. Therefore, the uplink RSSI is a function of the transmit power of the UEs, the UE-base station path loss, the base station receiver gain, and the UE uplink traffic demand.

Thus, in one example, the threshold value may be set to a value that is lower than an RSSI value corresponding to the maximum RF power that the base station can tolerate (i.e., the base station's saturation point). Setting the threshold value to a value below the RSSI value that corresponds to saturation may prevent the base station from becoming saturated, since exceeding the threshold will trigger actions to reduce the potential for saturation, as discussed in greater detail below.

If the processing system concludes in step 206 that the current value of the received signal strength indicator is not greater than the threshold value, then the method 200 may return to step 204, and the processing system may continue to monitor the current value of the received signal strength indicator as described above.

If, however, the processing concludes in step 206 that the current value of the received signal strength indicator is greater than the threshold value, then the method 200 may proceed to step 208. In step 208, the processing system may identify a first user equipment of the plurality of user equipment for which a contribution to the current value of the received signal strength indicator is largest.

In one example, the processing system may be able to determine the individual contributions of the plurality of UEs to the current value of the RSSI. For instance, mathematical models which take into consideration the actual UE transmit power, the UE amplifier gain, the base station amplifier gain, and the UE-base station path loss may be able to estimate the contribution of each UE of the plurality of UEs to the current value of the RSSI. The mathematical models may be created based on observations and pre-recorded values, or may comprise prediction models that utilize machine learning techniques.

Thus, the processing system may be able to determine which UEs of the plurality of UEs contribute the most to the current value of the RSSI (e.g., which UEs of the plurality of UEs are currently operating with the highest transmit power). In one example, the first UE may be the UE for which the contribution to the current value of the RSSI is the largest among all UEs of the plurality of UEs. In another example, the first UE may be a UE for which the contribution to the current value of the RSSI is one of the top n largest among all UEs of the plurality of UEs. It should be noted that a large UAV transmitting at a high power close to the base station will typically contribute more to the RSSI than another type of UE transmitting at lower power far away from the base station.

As discussed above, large non-recreational use UAVs may have very high transmit power. Thus, the closer these large non-recreational use UAVs fly to the base station, the greater the contributions of these UAVs to the base station's RSSI will be. Conversely, the further these large non-recreational use UAVs fly from the base station, the smaller the contributions of these UAVs to the base station's RSSI will be. Thus, in one example, the first UE may be a UAV. More specifically, in one example, the first UE may be a non-recreational UAV, such as the type of UAV used by first responders and for industrial, military, and commercial (e.g., parcel delivery) applications.

In step 210, the processing system may send an instruction to the first user equipment to cause the first user equipment to adjust at least one of: a current transmit power of the first user equipment, a physical distance of the first user equipment from the base station, or a current serving cell of the first user equipment.

In one example, the instruction may comprise a transmit power control feedback message, similar to that used in OLPC or CLPC.

There are many ways in which the magnitude of the first UE's contribution to the base stations RSSI may be reduced. For instance, in one example, the processing system may calculate an amount by which the first UE's transmit power must be reduced to lower the current value of the RSSI below the threshold (or to some other desired values). The processing system may either specify an amount by which the first UE should lower its transmit power (e.g., “lower the transmit power by x Watts”) or a level to which the first UE should lower its transmit power (e.g., “lower the transmit power to y Watts”).

In another example, the processing system may calculate a distance by which the first UE must move away from the base station to lower the current value of the RSSI below the threshold (or to some other desired values). In this case, the processing system may have access to data which correlates distance with RSSI for various types, makes, and/or models of UEs. Thus, the processing system may be able to estimate how far the first UE is from the base station (or may have access to global positioning system coordinates or other location data for the first UE), as well as how much further away the first UE must be from the base station to lower the current value of the RSSI below the threshold. The processing system may either specify a distance by which the first UE should move away from the base station (e.g., “move x miles away from the base station”) or a location to which the first UE should move (e.g., “move to coordinates x, y, z”).

In another example, the processing system may simply request that the first UE connect to a different base station. In one example, the processing system may poll one or more base stations whose serving cells are within range of the current position of the first UE. The processing system may determine, based on the polling, which of these one or more base stations may be capable of serving the first UE without becoming saturated. In this case, the processing system may recommend one or more specific different base stations (candidate base stations) to the first UE that are capable of serving the first UE. However, the first UE may still elect to connect to a base station other than a base station that is recommended by the processing system.

The method 200 may then return to step 204, and the processing system may continue to monitor the current value of the received signal strength indicator as described above.

Thus, the processing system may continuously iterate through steps 204-210. The value of the current RSSI may change over time as different UEs join the cell served by the base station and/or leave the cell served by the base station, so continuous monitoring of the RSSI value may ensure that the processing system always acts to minimize the possibility of the base station becoming saturated before actual saturation of the base station occurs.

FIG. 3 illustrates a flowchart of an example method 300 for automatically adjusting the operation of unmanned aerial vehicles to avoid base station receive power saturation, according to the present disclosure. In one example, the method 300 may be performed by a base station of a radio access network, such as one of the base stations 134, 136, 138, or 140 illustrated in FIG. 1 or one or more components thereof (e.g., a processor or controller of the base station). However, in other examples, the method 300 may be performed by another device, such as the computing system 400 of FIG. 4, discussed in further detail below. For the sake of discussion, the method 300 is described below as being performed by a processing system (where the processing system may comprise a component of a base station 134, 136, 138, 140, the computing system 400, or another device).

The method 300 begins in step 302. In step 304, the processing system may monitor identifiers of a plurality of user equipment currently being served by a base station of a wireless network.

In one example, the wireless communications network comprises a radio access network (RAN), such as an LTE, 4G, 5G, or beyond 5G (B5G) network. Thus, the base station may comprise an eNodeB or a gNodeB. In one example, the RSSI is an uplink RSSI. Thus, the uplink RSSI may measure the collective power of the uplink radio signals received by the base station from the plurality of user equipment.

The plurality of user equipment may include various types of mobile devices, including smart phones, tablet computers, portable gaming consoles, wearable smart devices (e.g., fitness trackers, smart watches, smart glasses, or the like), UAVs, autonomous vehicles, Internet of Things (IoT) devices, and the like. In one example, the identifiers may comprise strings of letters and/or numbers that uniquely identify the plurality of UEs, such as international mobile subscriber identities (IMSIs).

In step 306, the processing system may determine, based on the monitoring, whether an identifier is detected that indicates that the base station is currently serving an unmanned aerial vehicle.

As discussed above, IMSIs (or other types of identifiers) uniquely identify UEs. Thus, the processing system may be able to tell (e.g., based on a mapping of identifiers to devices), based on the IMSIs, whether any of the UEs are UAVs. More specifically, the processing system may be able to tell, based on the IMSIs, whether any of the UEs are larger, non-recreational UAVs such as those used by first responders and in industrial, military, and commercial applications.

As also discussed above, the presence of a larger, non-recreational UAV in the serving area of a base station may pose a saturation risk to the base station, particularly if the UAV flies in close proximity to the base station will be transmitting at a relatively high transmit power.

If the processing system concludes in step 306 that an identifier has not been detected that indicates that the base station is currently serving an unmanned aerial vehicle, then the method 300 may return to step 304, and the processing system may continue to monitor the identifiers of a plurality of user equipment currently being served by a base station of a wireless network as described above.

If, however, the processing system concludes in step 306 that an identifier has been detected that indicates that the base station is currently serving an unmanned aerial vehicle, then the method 300 may proceed to step 308. In step 308, the processing system may send an instruction to the unmanned aerial vehicle that causes the unmanned aerial vehicle to reduce a transmit power of the unmanned aerial vehicle.

In one example, the processing system may first calculate a probability that a contribution of the UAV to an RSSI of the base station will cause a threshold RSSI value to be exceeded. As discussed above, the threshold value may be set to a value that is lower than an RSSI value corresponding to the maximum RF power that the base station can tolerate (i.e., the base station's saturation point). Setting the threshold value to a value below the RSSI value that corresponds to saturation may prevent the base station from becoming saturated, since exceeding the threshold will trigger actions to reduce the potential for saturation, as discussed in greater detail below.

In one example, the processing system may calculate an amount by which the UAV's transmit power must be reduced to maintain the RSSI below the threshold value (or to some other desired values). The processing system may either specify an amount by which the UAV should lower its transmit power (e.g., “lower the transmit power by x Watts”) or a level to which the UAV should lower its transmit power (e.g., “lower the transmit power to y Watts”).

The method 300 may then return to step 304, and the processing system may continue to monitor the identifiers of a plurality of user equipment currently being served by a base station of a wireless network as described above.

Thus, the processing system may continuously to iterate through steps 304-308. Unlike the method 200, in which a mitigating action (e.g., instruction to a UE) is triggered by an event which indicates a base station may be approaching saturation, the method 300 seeks to proactively avoid getting to the point where saturation is approached. Specifically, the method 300 seeks to detect when a device that may trigger saturation (e.g., a larger non-recreational UAV) enters the serving area of a base station, and to take measures to alter the operation of that device before signs of possible impending saturation are visible.

The methods 200 and 300 may therefore be used to monitor and adjust the uplink transmit power level for high-power UAVs being served by terrestrial 5G RANs, by means of fine-tuning uplink power control settings. Examples of the present disclosure assume that the UAVs will use CLPC or a similar mechanism, which allows for feedback from base stations of a RAN. Although examples of the present disclosure are discussed as being performed by the base stations, in other examples, the methods 200 and 300 could be performed by other devices in a RAN, such as a self-optimizing network (SON) controller, a radio intelligent controller (RIC), or another centralized solution.

Thus, the methods 200 and 300 may minimize the occurrence of base station saturation in RANs, ensuring stable and efficient RAN operations with optimal uplink signal quality by managing power contributions from UEs including large UAVs. Efficiently allocating uplink power resources will also reduce interference and optimize network capacity by ensuring the high-power UAVs do not disproportionately affect the network. Predictive models may be used to foresee potential saturation threats and address these threats before they affect RAN performance.

Although not expressly specified above, one or more steps of the method 200 or the method 300 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or method 300 may be implemented as the system 400. For instance, any one or more of the base stations 134, 136, 138, or 140 of FIG. 1 (such as might be used to perform the method 200 or the method 300) could be implemented as illustrated in FIG. 4. As depicted in FIG. 4, the system 400 comprises a hardware processor element 402, a memory 404, a module 405 for automatically adjusting the operation of unmanned aerial vehicles to avoid base station receive power saturation, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for automatically adjusting the operation of unmanned aerial vehicles to avoid base station receive power saturation may include circuitry and/or logic for monitoring RSSI at a RAN base station and calculating adjustments to UE transmit power and/or trajectories to lower the RSSI. The input/output devices 406 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for automatically adjusting the operation of unmanned aerial vehicles to avoid base station receive power saturation can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for automatically adjusting the operation of unmanned aerial vehicles to avoid base station receive power saturation (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
monitoring, by a processing system including at least one processor, a current value of a received signal strength indicator of a base station of a wireless communications network that is serving a plurality of user equipment;
determining, by the processing system, that the current value of the received signal strength indicator is greater than a threshold value;
identifying, by the processing system, a first user equipment of the plurality of user equipment for which a contribution to the current value of the received signal strength indicator is largest; and
sending, by the processing system, an instruction to the first user equipment to cause the first user equipment to adjust at least one of: a current transmit power of the first user equipment, a physical distance of the first user equipment from the base station, or a current serving cell of the first user equipment.

2. The method of claim 1, wherein the wireless communications network comprises a radio access network.

3. The method of claim 2, wherein the processing system is part of the base station.

4. The method of claim 2, wherein the processing system is part of a controller of the radio access network.

5. The method of claim 4, wherein the controller is one of: a self-optimizing network controller or a radio intelligent controller.

6. The method of claim 1, wherein the current value of the received signal strength indicator measures a collective power of uplink radio signals received by the base station from the plurality of user equipment.

7. The method of claim 6, wherein the threshold value is set to a value that is lower than a received signal strength indicator value corresponding to a saturation point of the base station.

8. The method of claim 1, wherein the instruction causes the first user equipment to reduce the current transmit power to a level that lowers the current value of the received signal strength indicator below the threshold value.

9. The method of claim 8, wherein the instruction specifies the level.

10. The method of claim 8, wherein the instruction specifies an amount by which to reduce the current transmit power to reach the level.

11. The method of claim 1, wherein the instruction causes the first user equipment to move to a new location that is further away from the base station than a current location of the first user equipment.

12. The method of claim 11, wherein the instruction specifies a distance by which to move to reach the new location.

13. The method of claim 11, wherein the instruction specifies coordinates of the new location.

14. The method of claim 2, wherein the current serving cell is a cell of the radio access network that is served by the base station, and the instruction causes the first user equipment to move to a serving cell served by a different base station.

15. The method of claim 14, wherein the instruction identifies at least one candidate base station that is capable of serving the first user equipment without becoming saturated.

16. The method of claim 15, wherein the different base station is one of the at least one candidate base station.

17. The method of claim 1, wherein the first user equipment is a non-recreational unmanned aerial vehicle.

18. The method of claim 17, wherein the non-recreational unmanned aerial vehicle transmits at at least ten watts.

19. A non-transitory computer-readable medium storing instructions which, when executed by a processing system including at least one processor, cause the processing system to perform operations, the operations comprising:
monitoring a current value of a received signal strength indicator of a base station of a wireless communications network that is serving a plurality of user equipment;
determining that the current value of the received signal strength indicator is greater than a threshold value;
identifying a first user equipment of the plurality of user equipment for which a contribution to the current value of the received signal strength indicator is largest; and
sending an instruction to the first user equipment to cause the first user equipment to adjust at least one of: a current transmit power of the first user equipment, a physical distance of the first user equipment from the base station, or a current serving cell of the first user equipment.

20. A system comprising:
a processing system including at least one processor; and
a non-transitory computer-readable medium storing instructions which, when executed by the processing system, cause the processing system to perform operations, the operations comprising:
monitoring a current value of a received signal strength indicator of a base station of a wireless communications network that is serving a plurality of user equipment;
determining that the current value of the received signal strength indicator is greater than a threshold value;
identifying a first user equipment of the plurality of user equipment for which a contribution to the current value of the received signal strength indicator is largest; and
sending an instruction to the first user equipment to cause the first user equipment to adjust at least one of: a current transmit power of the first user equipment, a physical distance of the first user equipment from the base station, or a current serving cell of the first user equipment.
